(19) United States
(12) Patent Application Publication
(10) Pub. No.: US 2025/0062662 A1
(43) Pub. Date: Feb. 20, 2025

(54) MOTOR COOLING DEVICE AND MOTOR INCLUDING THE SAME

(71) Applicant: KORENSEM INC., Busan (KR)

(72) Inventor: Tae Hun KIM, Changwon-si Gyeongsangnam-do (KR)

(73) Assignee: KORENSEM INC., Busan (KR)

(21) Appl. No.: 18/785,274

(22) Filed: Jul. 26, 2024

(30) Foreign Application Priority Data
Aug. 18, 2023 (KR) 10-2023-0108218

(51) Int. Cl. H02K 9/19; H02K 1/16

(52) U.S. Cl. CPC H02K 9/19; H02K 1/16

(57) ABSTRACT

The present disclosure relates to a motor cooling device and a motor including an oil cooling system. An embodiment of the present disclosure provides a motor including a stator assembly including an end coil which includes a plurality of layers and is externally exposed, an oil guide disposed in front of or behind the stator assembly, and a partition wall disposed above and spaced apart from the end coil, wherein the oil guide includes a guide body, one inlet hole formed in one surface of the guide body, and a plurality of outlet holes formed in another surface of the guide body, wherein the plurality of outlet holes are formed in different shapes according to positions at which the plurality of outlet holes are disposed.

### CROSS-REFERENCE TO RELATED APPLICATION

This application is based on and claims priority under 35 USC § 119 to Korean Patent Application No. 10-2023-0108218, filed on Aug. 18, 2023, in the Korean Intellectual Property Office, the disclosure of which is incorporated by reference herein in its entirety.

### BACKGROUND

### 1. Field

The present disclosure relates to a motor cooling device and a motor including the same.

### 2. Description of the Related Art

An electric vehicle includes a driving unit which serves as an engine and a transmission of an internal combustion engine and converts electrical energy from a high-voltage battery into mechanical energy. The driving unit includes a motor, an inverter, and a reducer, and heat dissipation performance is directly related to the performance of a driving motor and thus is an important design element.

Recently, as miniaturized, lightweight, and high-efficiency driving devices have been required, a lot of heat is generated during driving, and thus in order to prevent a decrease in efficiency due to durability of components and heat loss, there is a need for a structure in which a cooling structure is simplified to facilitate manufacturing and which is capable of improving cooling efficiency.

Methods of cooling motors include air cooling methods using forced convection of surrounding air, water cooling methods using a coolant in a motor housing or external cover, and oil cooling methods using oil for directly cooling a heat source. Air cooling, water cooling, oil cooling, or hybrid methods are selected according to the characteristics of each product. Recently, as the demand for high-efficiency and high-power motors continues to increase, direct cooling methods using cooling oil have been widely used. However, direct cooling methods using oil have a problem in that a certain part of a motor may become overheated due to uneven distribution of cooling oil in a driving motor. In addition, in cooling windings which are main heat sources of motors, the flow characteristics according to the number of rotations may not be reflected, and thus there is a possibility that hot spots may occur locally.

### SUMMARY

The present disclosure has been made in an effort to solve the above problems and is directed to providing a motor cooling device with improved cooling performance, which is a technology for analyzing the flow characteristics of cooling oil according to the number of rotations of a motor and reusing an unnecessary secondary flow of cooling oil, which occurs at a high rotation speed, for cooling a winding, and a motor including the same.

Additional aspects will be set forth in part in the description which follows and, in part, will be apparent from the description, or may be learned by practice of the presented embodiments of the disclosure.

An embodiment of the present disclosure provides a motor including a stator assembly including an end coil which includes a plurality of layers and is externally exposed, an oil guide disposed in front of or behind the stator assembly, and a partition wall disposed above and spaced apart from the end coil, wherein the oil guide includes a guide body, one inlet hole formed in one surface of the guide body, and a plurality of outlet holes formed in another surface of the guide body, wherein the plurality of outlet holes are formed in different shapes according to positions at which the plurality of outlet holes are disposed.

In an embodiment of the present disclosure, the guide body may have an annular structure having open one side.

In an embodiment of the present disclosure, the guide body may have a structure that is asymmetric with respect to a center of the guide body.

In an embodiment of the present disclosure, the guide body may extend to have different lengths with respect to an imaginary line passing through the center of the guide body and a rotation axis of the motor.

In an embodiment of the present disclosure, the plurality of outlet holes may include a first type outlet hole formed adjacent to a center of the guide body, and a second type outlet hole formed farther from the center of the guide body than the first type outlet hole, wherein the first type outlet hole has a shape of a long slit which is elongated in a longitudinal direction of the guide body, and the second type outlet hole is formed as a circular hole.

In an embodiment of the present disclosure, the first type outlet hole may be formed symmetrically with respect to the center of the guide body.

In an embodiment of the present disclosure, the first type outlet hole may include a protruding nozzle portion.

In an embodiment of the present disclosure, when the first type outlet hole is provided as a plurality of first type outlet holes, the first type outlet hole formed in the center of the guide body may be wider than other first type outlet holes.

In an embodiment of the present disclosure, the partition wall may be disposed outside the oil guide with respect to a rotation axis of the motor.

In an embodiment of the present disclosure, the second type outlet hole may be formed inward in the guide body to face a center of the stator assembly.

An embodiment of the present disclosure provides a motor cooling device including an oil guide disposed in front of or behind a stator assembly including an end coil which includes a plurality of layers and is externally exposed, wherein the oil guide includes a guide body, one inlet hole formed in one surface of the guide body, and a plurality of outlet holes formed in another surface of the guide body, wherein the guide body is formed in an annular structure having open one side and has a structure that is asymmetric with respect to a center of the guide body.

In an embodiment of the present disclosure, one end portion of the guide body in a same direction as a rotation direction of the stator assembly may be formed to be shorter than another end portion opposite to the one end portion.

In an embodiment of the present disclosure, the plurality of outlet holes may include a first type outlet hole formed adjacent to a center of the guide body, and a second type outlet hole formed farther from the center of the guide body than the first type outlet hole, wherein the first type outlet hole has a shape of a long slit which is elongated in a longitudinal direction of the guide body, and the second type outlet hole is form ed as a circular hole.

In an embodiment of the present disclosure, the first type outlet hole may be formed symmetrically with respect to the center of the guide body.

In an embodiment of the present disclosure, the first type outlet hole may include a protruding nozzle portion.

In an embodiment of the present disclosure, when the first type outlet hole is provided as a plurality of first type outlet holes, the first type outlet hole formed at the center of the guide body may be wider than other first type outlet holes.

In an embodiment of the present disclosure, the second type outlet hole may be formed inward in the guide body to face a center of the stator assembly.

In an embodiment of the present disclosure, the motor cooling device may further include a partition wall disposed above and spaced apart from the end coil.

In an embodiment of the present disclosure, the partition wall may be disposed outside the oil guide with respect to a rotation axis of the motor.

In an embodiment of the present disclosure, the partition wall may have a longer circumference than the oil guide.

Other aspects, features and advantages in addition to those described above will become apparent from the following drawings, claims and detailed description of the invention.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a plan view illustrating an oil guide, a partition wall, and a stator assembly in a motor according to an embodiment of the present disclosure;

FIG. 2 is a partial enlarged view illustrating a portion of an end coil and side surfaces of the oil guide and the partition wall of FIG. 1;

FIG. 3 is a front view illustrating the oil guide and the partition wall in the motor according to an embodiment of the present disclosure;

FIG. 4 is a perspective view illustrating an oil guide of a motor according to an embodiment of the present disclosure;

FIG. 5 is a front view illustrating the oil guide of FIG. 4;

FIG. 6 is a view illustrating an oil flow state when a motor not including a partition wall rotates at a low speed according to an embodiment of the present disclosure; and

FIG. 7 is a view illustrating an oil flow state when a motor not including a partition wall rotates at a high speed according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, the following embodiments will be described in detail with reference to the accompanying drawings, wherein like reference numerals refer to the same or corresponding components throughout the drawings, and a redundant description thereof will be omitted.

In describing the present disclosure, when it is determined that the specific description of the related known function or configuration may unnecessarily obscure the gist of the embodiments of the present disclosure, the detailed description thereof will be omitted.

The present embodiments may have various modifications, and thus specific embodiments are illustrated in the drawings and described in detail in the detailed description. The effects and features of the present embodiments and methods for achieving them will be apparent with reference to the following detailed description together with the drawings. However, the present embodiments are not limited to the embodiments disclosed below and may be implemented in various forms.

In the drawings, in order to clearly describe the present disclosure, parts not related to the description will be omitted, and he same or similar components throughout the specification will be assigned the same reference numbers.

In the following embodiments, the terms first, second, and the like do not have limited meaning but are used for the purpose of distinguishing one component from another component.

In the following embodiments, the expressions used in the singular such as “a,” “an,” and “the” are intended to include the plural forms as well, unless the context clearly indicates otherwise.

In the following embodiments, it will be understood that the terms such as “including,” “comprising,” and “having” specify the presence of stated features or components, but do not preclude the presence or addition of one or more other features or components.

In the following embodiments, when a unit, an area, a component, or the like is positioned on or above another part, the present disclosure includes not only a case in which the unit, the area, the component, or the like is positioned directly above the other part, but also a case in which other units, other areas, other component, or the like may be positioned therebetween.

In the following embodiments, unless the terms “connecting” or “coupling” are clearly different in context, the terms “connecting” or “coupling” do not necessarily mean direct and/or fixed connection or coupling of two members, but do not exclude a member positioned between the two members.

In the drawings, components may be exaggerated or reduced in size for convenience of description. For example, the sizes and thicknesses of the respective components shown in the drawings are arbitrarily shown for convenience of description, and thus the following embodiments are not necessarily limited thereto.

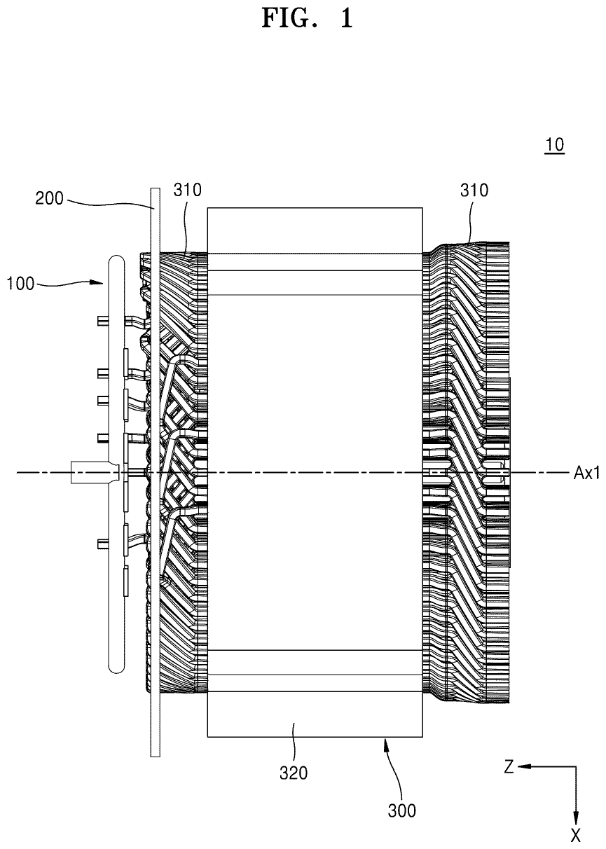

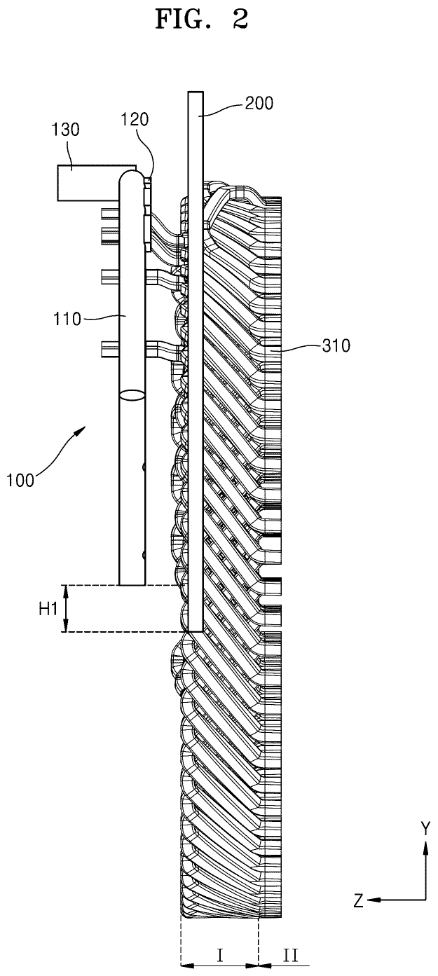

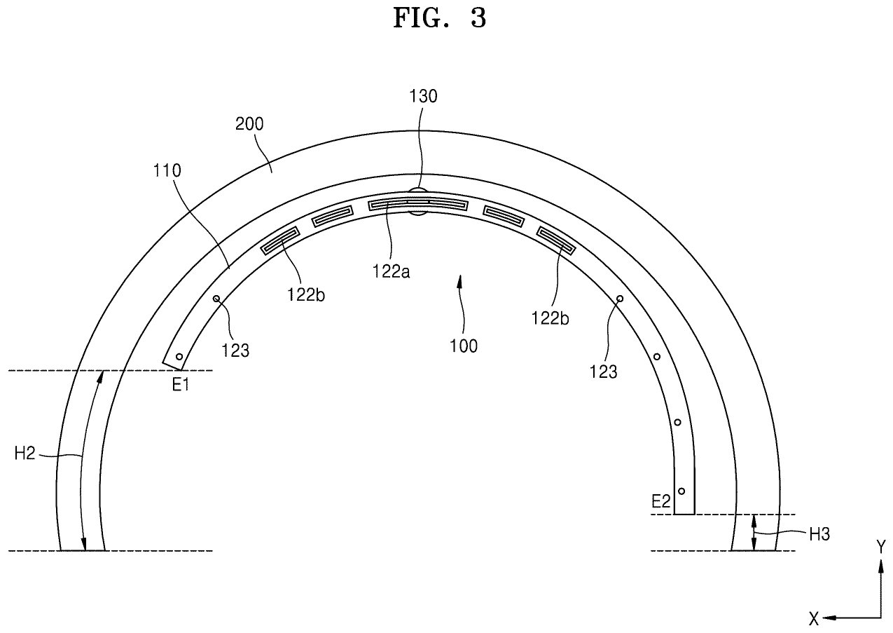

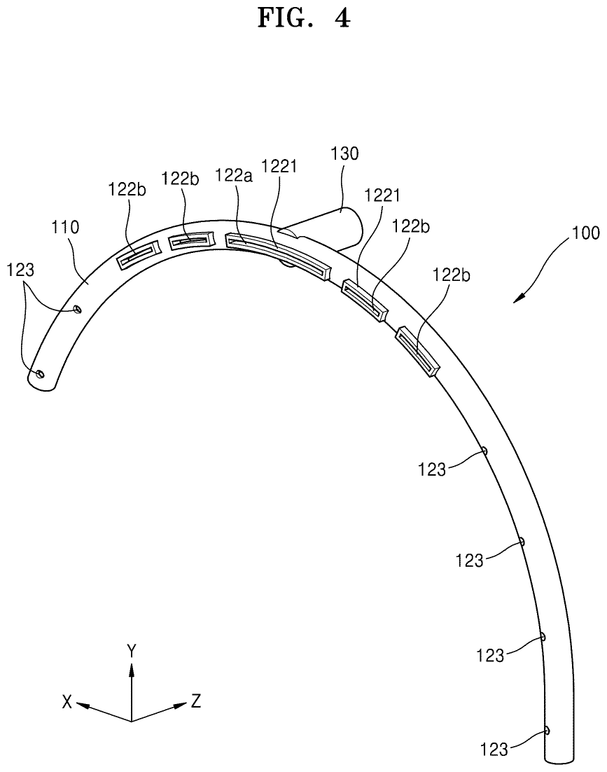

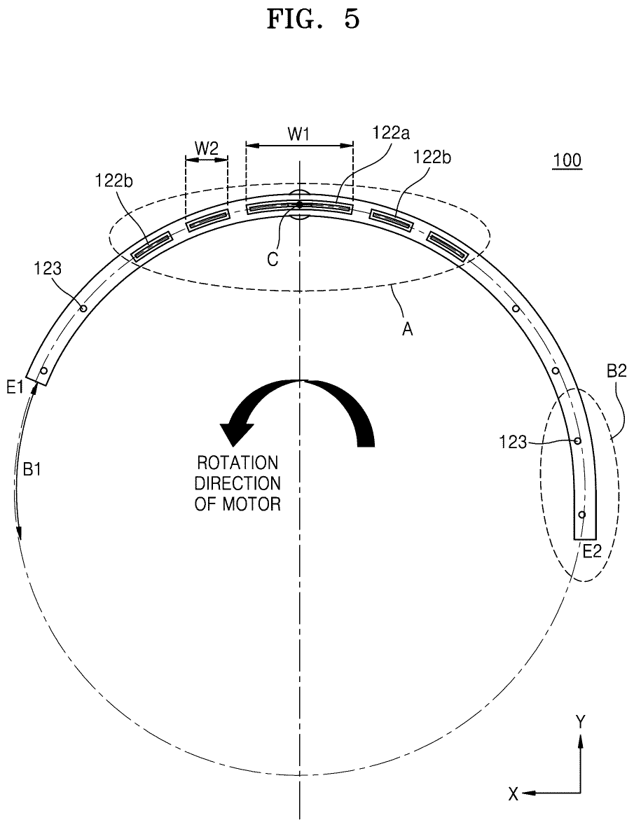

FIG. 1 is a plan view illustrating an oil guide 100, a partition wall 200, and a stator assembly 300 in a motor 10 according to an embodiment of the present disclosure. FIG. 2 is a partially enlarged view illustrating a portion of an end coil 310 and side surfaces of the oil guide 100 and the partition wall 200 of FIG. 1. FIG. 3 is a front view illustrating the oil guide 100 and the partition wall 200 in the motor 10 according to an embodiment of the present disclosure. FIG. 4 is a perspective view illustrating the oil guide 100 of the motor 10 according to an embodiment of the present disclosure. FIG. 5 is a front view illustrating the oil guide 100 of FIG. 4.

Referring to FIG. 1, the motor 10 according to an embodiment of the present disclosure may include the stator assembly 300, the oil guide 100, and the partition wall 200.

The stator assembly 300 may include a stator core 320, a plurality of wound coils, and the end coil 310 exposed to the outside.

A plurality of teeth and a plurality of slots may be formed at an inner edge of the stator core 320, and a rotor (not shown) that rotates about a center of the stator core 320 and includes a plurality of magnets may be disposed inside the stator core 320.

As an embodiment, the motor 10 may be a hairpin motor. Motors may be classified according to a coil winding method. Among types of motors according to the coil winding method, in particular, in the hairpin motor, as shown in FIG. 1, coils may be arranged at an oblique angle at both ends of the stator core 320.

Here, the coils may have a structure in which the coils are inserted and stacked in the plurality of slots formed at the inner edge of the stator core 320 so as to intersect each other. The coils may have basic rectangular wire patterns having a constant pitch interval, and modified rectangular wire patterns having a pitch interval different from that of the basic rectangular wire patterns. In this case, in the present specification, a portion of the coil exposed to the outside of the stator core 320 will be referred to as the end coil 310 and will be described.

The end coil 310 may have a structure that protrudes outward from each end of the stator core 320. Specifically, the end coil 310 may include a front end coil 310 and a rear end coil 310, wherein, when viewed from a front or rear of the motor 10, the front end coil 310 protrudes from a front of the stator core 320, and the rear end coil 310 protrudes from a rear of the stator core 320.

As described above, due to a structure in which the coils are inserted and stacked to intersect each other, the end coil 310 may have a structure in which a plurality of layers are stacked when viewed from the front or rear.

Referring further to FIG. 2, a certain area I at an end portion of the end coil 310 may have an unaligned structure due to hairpin windings intersecting each other, and an area II connected thereto may have a structure in which hairpin windings are aligned with each other.

Meanwhile, the oil guides 100 may be disposed in front of and behind the stator assembly 300 and may perform a function of cooling the motor 10 by spraying oil toward the end coil 310.

Referring to FIGS. 2 to 5, in an embodiment of the present disclosure, the oil guide 100 may include a guide body 110, an outlet hole 120, and an inlet hole 130.

Here, the guide body 110 may form a body of the oil guide 100, and a space or flow path may be formed inside the guide body 110 to guide oil flowing in through the inlet hole 130 to flow out through the outlet hole 120. The internal flow path may be formed to have a certain thickness along a curved shape to uniformly supply oil to a plurality of outlet holes 120, but the present disclosure is not limited thereto.

The guide body 110 may be formed in a curved shape corresponding to the end coil 310. For example, the guide body 110 may be formed in a semicircular or arc shape or an annular structure with open one side. That is, the guide body 110 may have a shape corresponding to a portion of a circumference of a circle with a certain diameter centered on a rotation axis of the motor 10.

In addition, the guide body 110 may have a structure that is laterally asymmetric. Referring to FIG. 5, in the present specification, when the oil guide 100 is installed on the stator assembly 300 to correspond to the end coil 310, an upper center of the oil guide 100 is defined as a center C of the guide body 110. In this case, the guide body 110 may have a structure that is asymmetric with respect to the center C of the guide body 110.

Specifically, the guide body 110 may have left and right sides that extend to have different lengths with respect to an imaginary line passing through the center C of the guide body 110 and the rotation axis of the motor 10. In FIG. 5, a one-dot chain line parallel to a Y-axis direction may be regarded as the imaginary line passing through a center of the guide body 110 and the rotation axis of the motor 10. In this case, the lengths of the left and right sides of the guide bodies 110 may be different with respect to the imaginary line in the drawing. In other words, a length from the center C of the guide body 110 to one end E1 of the guide body 110 may be shorter than a length from the center C of the guide body 110 to another end E2 of the guide body 110.

The asymmetric structure of the guide body 110 may be determined in consideration of a rotation direction of the motor 10. That is, in the motor 10 according to an embodiment of the present disclosure, in consideration of oil flow characteristics caused by the rotation of the motor 10, the guide body 110 may be formed asymmetrically to compensate for cooling in an area in which a cooling effect is relatively low.

For example, as shown in FIG. 5, when the motor 10 rotates counterclockwise, the end coil 310 corresponding to a right portion (area B2) of the oil guide 100 in the drawing has a relatively small amount of sprayed oil, and the end coil 310 corresponding to a left portion (area B1) of the oil guide 100 has a relatively large amount of oil. Therefore, a cooling effect is relatively reduced in the area B2, and thus a local hot spot is present. In this way, since spray characteristics need to be dualized at both sides of the oil guide 100 in consideration of the oil flow characteristics due to the rotation of the motor 10, the guide body 110 may be formed in an asymmetric structure with different left and right lengths.

As an embodiment of the present disclosure, as shown in FIG. 5, in the guide body 110, one end portion E1 in the same direction as a rotation direction (counterclockwise direction) of the motor 10 may be formed to be shorter than another end portion E2 in a direction opposite to the one end portion E1.

Meanwhile, the oil guide 100 may include one inlet hole 130 formed in one surface of the guide body 110 and the plurality of outlet holes 120 formed in another surface of the guide body 110.

Here, the plurality of outlet holes 120 may be disposed along the curved shape of the guide body 110 to be spaced apart from each other. In addition, the plurality of outlet holes 120 may be formed in different shapes according to positions at which the plurality of outlet holes 120 are disposed.

In an embodiment of the present disclosure, the plurality of outlet holes 120 may include a first type outlet hole 122 disposed adjacent to the center of the guide body 110 and a second type outlet hole 123 disposed farther from the center of the guide body 110 than the first type outlet hole 122.

The first type outlet hole 122 may have a shape of a long slit in a longitudinal direction of the guide body 110, and the second type outlet hole 123 may be formed as a circular hole.

When the first type outlet hole 122 is formed in a shape of a long slit or a shape of a rectangular nozzle as shown above, cooling oil may be applied onto a wide area of an upper portion of the end coil 310, and the applied oil may cool a space between windings by flowing downward along the end coil 310 by gravity.

In addition, when the second type outlet hole 123 is formed in a shape of a circular hole, oil may be sprayed over a relatively large area at a short distance, and oil may be sprayed through the plurality of outlet holes 120 at a limited flow rate, thereby maximizing a cooling effect.

In addition, the second type outlet hole 123 may be disposed inward in the guide body 110 toward a center of the stator assembly 300. That is, rather than being formed in a direction parallel to an axial direction of the motor 10, the second type outlet hole 123 may be formed closer to the axial direction of the motor 10.

Referring to FIG. 5, when it is assumed that the guide body 110 is formed along a circumference of a circle with a certain diameter, a shape of the circle is shown as a dotted line. In an embodiment, the second type outlet hole 123 may not be disposed on the dotted line, but may be disposed inside the circle.

Referring to FIGS. 4 and 5, in an embodiment, the first type outlet hole 122 may be formed to be laterally symmetric with respect to the center C of the guide body 110. For example, a first type outlet hole 122a positioned at the center C of the guide body 110 is formed in a shape that is laterally symmetric, and first type outlet holes 122b at both sides of the first type outlet hole 122a at the center C may be disposed to be laterally symmetric with each other with respect to the center C.

In addition, in an embodiment, the first type outlet hole 122a positioned at the center C of the guide body 110 may have a wider hole than other first type outlet holes 122b. This is to spray oil over a wide range of an upper winding of the end coil 310 and cool a gap between windings to maximize a cooling effect.

Meanwhile, the first type outlet hole 122 may include a protruding nozzle portion 1221. The nozzle portion 1221 may be formed along a perimeter of the first type outlet hole 122 and may have a shape that protrudes from the guide body 110 by a certain thickness.

An angle of the nozzle portion 1221 of the first type outlet hole 122 may be parallel to the axial direction of the motor 10, but the present disclosure is not limited thereto. The nozzle portion 1221 may serve as a guide for spraying oil in the entirety of a longitudinal direction of a winding while maintaining a certain interval between the winding and a nozzle and may serve to improve horizontal moment of the sprayed oil.

In an embodiment of the present disclosure, the inlet hole 130 may be formed in another surface of the guide body 110 which is opposite to one surface in which the plurality of outlet holes 120 are formed. In this case, the inlet hole 130 may be formed in the center C of the guide body 110.

In another embodiment, the inlet hole 130 may be disposed to be biased from the center C of the guide body 110. That is, the inlet hole 130 does not need to be formed in the center C of the guide body 110 and may be disposed to be biased to the left or right.

Hereinafter, the partition wall 200 provided in the motor 10 according to an embodiment of the present disclosure will be described.

The partition wall 200 is a structure for preventing cooling loss due to a secondary flow of oil sprayed onto the end coil 310 from the oil guide 100 when the motor 10 rotates at a high speed and serves to prevent cooling oil from deviating from an area of the end coil 310.

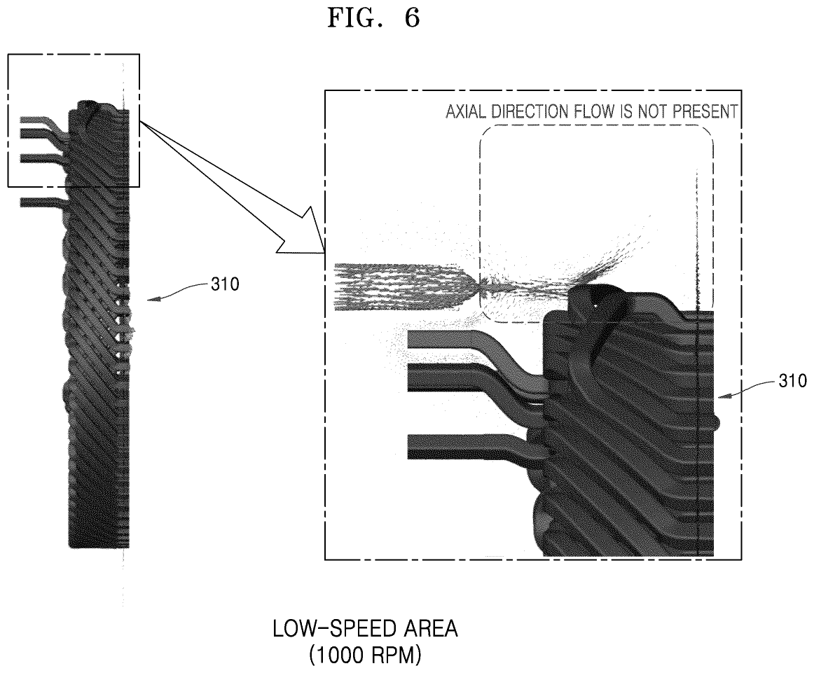

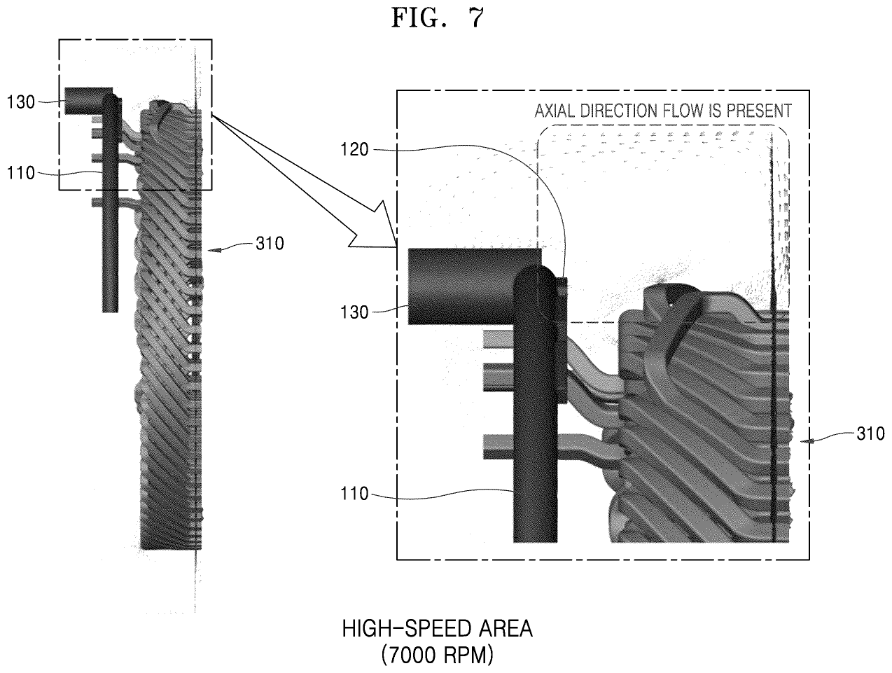

Referring to FIGS. 6 and 7, in a low-speed area in which the motor 10 rotates at a low speed, an axial direction flow is not present as a secondary flow of oil sprayed onto the end coil 310 from the oil guide 100. On the other hand, in a high-speed area in which the motor 10 rotates at a high speed, an axial direction flow is present as a secondary flow of sprayed oil.

The axial direction flow of oil in such a high-speed area does not sufficiently cool the end coil 310 and deviating oil is generated, thereby reducing an effect of cooling the oil guide 100. Therefore, in the motor 10 according to an embodiment of the present disclosure, the axial direction flow of oil is to be blocked through the partition wall 200.

In an embodiment, like the oil guide 100, the partition wall 200 may be formed in a semicircular or arc shape or an annular structure with open one side. That is, the partition wall 200 may have a shape corresponding to a portion of a circumference of a circle with a certain diameter centered on the rotation axis of the motor 10.

The partition wall 200 may be disposed above and spaced apart from the end coil 310 and may be disposed outside the oil guide 100 with respect to the rotation axis of the motor 10.

In addition, referring to FIG. 3, the partition wall 200 may be formed to have a longer circumference than the oil guide 100. That is, in the drawing, the partition wall 200 may be formed to be longer than one end portion E1 at a left side of the oil guide 100 by H2 and longer than the other end E2 portion at a right side of the oil guide 100 by H3. Unlike the oil guide 100, the partition wall 200 may have a shape that is laterally symmetric.

In a motor cooling device and the motor 10 including the same according to embodiments of the present disclosure, by applying the oil guide 100 to compensate for an area in which a cooling effect is relatively reduced, a local hot spot that may occur in the end coil 310 may be eliminated. In addition, the partition wall 200 may be provided to block the axial direction movement of oil that occurs when the motor 10 rotates at a high speed, and thus the unnecessary secondary flow of oil may be reused for cooling the end coil 310, thereby maximizing a cooling effect.

While the present disclosure has been described with reference to embodiments illustrated in the drawings, this is merely illustrative. It is to be understood that various modifications and variations of the embodiments can be made by a person having an ordinary skill in the art without departing from the spirit and scope of the present disclosure. Therefore, the true technical scope of the present disclosure should be defined by the technical spirit of the appended claims.

In a motor cooling device and a motor including the same according to embodiments of the present disclosure, by applying an oil guide to compensate for an area in which a cooling effect is relatively reduced, a local hot spot that may occur in an end coil may be eliminated. In addition, a partition wall may be provided to block the axial direction movement of oil that occurs when a motor rotates at a high speed, and thus the unnecessary secondary flow of oil may be reused for cooling an end coil, thereby maximizing a cooling effect.

Of course, the scope of the present disclosure is not limited by the effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A motor comprising:
a stator assembly comprising an end coil which includes a plurality of layers and is externally exposed;
an oil guide disposed in front of or behind the stator assembly; and
a partition wall disposed above and spaced apart from the end coil,
wherein the oil guide comprises a guide body, one inlet hole formed in one surface of the guide body, and a plurality of outlet holes formed on another surface of the guide body, and
wherein the plurality of outlet holes are formed in different shapes according to positions at which the plurality of outlet holes are disposed.

2. The motor of claim 1, wherein the guide body has an annular structure having open one side.

3. The motor of claim 2, wherein the guide body has a structure that is asymmetric with respect to a center of the guide body.

4. The motor of claim 3, wherein the guide body extends to have different lengths with respect to an imaginary line passing through the center of the guide body and a rotation axis of the motor.

5. The motor of claim 1, wherein the plurality of outlet holes comprise:
a first type outlet hole formed adjacent to a center of the guide body; and
a second type outlet hole formed farther from the center of the guide body than the first type outlet hole,
wherein the first type outlet hole has a shape of a long slit which is elongated in a longitudinal direction of the guide body, and
the second type outlet hole is formed as a circular hole.

6. The motor of claim 5, wherein the first type outlet hole is formed symmetrically with respect to the center of the guide body.

7. The motor of claim 5, wherein the first type outlet hole includes a protruding nozzle portion.

8. The motor of claim 6, wherein, when the first type outlet hole is provided as a plurality of first type outlet holes, the first type outlet hole formed in the center of the guide body is wider than other first type outlet holes.

9. The motor of claim 1, wherein the partition wall is disposed outside the oil guide with respect to a rotation axis of the motor.

10. The motor of claim 5, wherein the second type outlet hole is formed inward in the guide body to face a center of the stator assembly.

11. A motor cooling device comprising an oil guide disposed in front of or behind a stator assembly comprising an end coil which includes a plurality of layers and is externally exposed,
wherein the oil guide comprises a guide body, one inlet hole formed in one surface of the guide body, and a plurality of outlet holes formed in another surface of the guide body, and
wherein the guide body is formed in an annular structure having open one side and has a structure that is asymmetric with respect to a center of the guide body.

12. The motor cooling device of claim 11, wherein one end portion of the guide body in a same direction as a rotation direction of the stator assembly is formed to be shorter than another end portion opposite to the one end portion.

13. The motor cooling device of claim 11, wherein the plurality of outlet holes comprise:
a first type outlet hole formed adjacent to a center of the guide body; and
a second type outlet hole formed farther from the center of the guide body than the first type outlet hole,
wherein the first type outlet hole has a shape of a long slit which is elongated in a longitudinal direction of the guide body, and
the second type outlet hole is formed as a circular hole.

14. The motor cooling device of claim 13, wherein the first type outlet hole is formed symmetrically with respect to the center of the guide body.

15. The motor cooling device of claim 13, wherein the first type outlet hole comprises a protruding nozzle portion.

16. The motor cooling device of claim 14, wherein, when the first type outlet hole is provided as a plurality of first type outlet holes, the first type outlet hole formed at the center of the guide body is wider than other first type outlet holes.

17. The motor cooling device of claim 13, wherein the second type outlet hole is formed inward in the guide body to face a center of the stator assembly.

18. The motor cooling device of claim 11, further comprising a partition wall disposed above and spaced apart from the end coil.

19. The motor cooling device of claim 18, wherein the partition wall is disposed outside the oil guide with respect to a rotation axis of the motor.

20. The motor cooling device of claim 18, wherein the partition wall has a longer circumference than the oil guide.
